(19) United States
(12) Patent Application Publication
(10) Pub. No.: US 2019/0108232 A1
(43) Pub. Date: Apr. 11, 2019

(54) Systems and Methods for Reputation Verification

(71) Applicant: SyTRes LLC, Chicago, IL (US)

(72) Inventors: Craig J. Calcaterra, Minneapolis, MN (US); Wulf A. Kaal, Chicago, IL (US)

(73) Assignee: SyTRes LLC, Chicago, IL (US)

(21) Appl. No.: 16/154,462

(22) Filed: Oct. 8, 2018

Related U.S. Application Data
(60) Provisional application No. 62/606,853, filed on Oct. 10, 2017.

(51) Int. Cl. G06F 17/30; G06F 21/50

(52) U.S. Cl. CPC G06F 17/3089; G06F 21/50; G06F 17/30961

(57) ABSTRACT

The system described herein is an autonomous decentralized platform that facilitates a framework for the evolution of verified reputation for anonymous or identifiable users, human or machine. The platform can be built on decentralized or centralized networks, including a blockchain or distributed hash table. Described herein is the architecture's implementation in the case of a distributed network with anonymous users. Using a system of checks and balances, the platform is designed to address the Sybil attack and tyranny of the majority problems.

### REFERENCE TO RELATED APPLICATIONS

This application claims an invention which was disclosed in Provisional Application No. 62/606,853, filed Oct. 10, 2017, entitled “SYSTEMS AND METHODS FOR REPUTATION VERIFICATION.” The benefit under 35 USC § 119(e) of the United States provisional application is hereby claimed, and the aforementioned application is hereby incorporated herein by reference.

### BACKGROUND OF THE INVENTION

Public blockchains are decentralized, autonomous systems that allow transactions between anonymous parties. In particular, the Ethereum blockchain makes complicated transactions possible using so-called smart contracts. While Ethereum will be used as an example blockchain throughout, it is to be understood that the systems of the present invention may be implemented on any blockchain capable of supporting smart contracts, on distributed hash tables, or on centralized systems. Smart contracts are computer programs that execute transfers of assets (e.g., currency, property, reputation, work) between parties automatically, without intermediaries, which means the transactions are close to 0 cost. These smart contract blockchain transactions are self-regulating and self-enforcing, meaning business can be conducted without the need for any traditional legal enforcement mechanisms and without the need for traditional business infrastructure execution mechanisms. Smart contracts promise to be increasingly important in the global economy, for clarifying intent and for removing the inefficiencies of intermediators, guarantors, and regulators.

However in any system with anonymous actors, there is a fundamental problem of establishing trust between parties before business can confidently proceed. Traditionally, trust is established through centralized social structures, between parties with well-established identities. For the crypto economy to continue to develop while avoiding the inefficiencies of any centralized regulating authority, a system for fairly and accurately evaluating reputation is crucial. To successfully serve the crypto economy, any such system should also be decentralized, allow anonymity, and run autonomously.

In any such decentralized reputational system there is always the potential to corrupt the value of reputation by purchasing it directly, or through automated worthless work, or through the degeneration of a majority of inexpert opinions. These are the respective problems of corruption, Sybil attacks, and tyranny of the majority that have plagued all previous autonomous, decentralized reputation platforms.

### FIELD OF THE INVENTION

The invention pertains to the field of blockchain technology. More particularly, the invention pertains to using blockchain technology to identify and reward expertise within an reputation verification system.

### SUMMARY OF THE INVENTION

In a system for establishing and verifying reputation in a system in which one or more posters provide one or more posts and one or more experts evaluate the posts, a post is accepted within a forum, and reputation tokens are generated upon the acceptance of the post. In a betting pool, half of the generated reputation tokens are staked in favor of a proposition that the post improves expertise within the forum, and half of the generated reputation tokens are staked in favor of a proposition that the post does not improve expertise within the forum.

The betting pool further allows experts to bet on whether or not the post improves expertise by wagering reputation tokens. The wagered tokens are tallied and the proposition that has received more wagered tokens is the winning proposition. All of the wagered tokens are then allocated to the experts who wagered on the winning proposition. If the proposition that the post has improved expertise wins, the poster receives a portion of the wagered reputation tokens.

### BRIEF DESCRIPTION OF THE DRAWINGS

FIG. 1 shows the organization of experts, expertises, and posts within a forum according to one embodiment of the present invention;

FIG. 2 shows the interaction of public users with a forum according to one embodiment of the present invention;

FIG. 3 shows the minting and staking of tokens according to one embodiment of the present invention;

FIG. 4 shows an example of upvotes and downvotes being placed using tokens according to one embodiment of the present invention;

FIG. 5 shows the selection of experts by relative weight of reputation according to one embodiment of the present invention; and

FIG. 6 shows a platform flowchart according to one embodiment of the present invention.

### DETAILED DESCRIPTION OF THE INVENTION

The described architecture provides a system of checks and balances which incentivizes productive work and punishes counterproductive work. The platform requires staking valuable reputation for each action. The system as described herein may be implemented in several embodiments, and not all embodiments include all of the features described.

The reputation platform entails 2 concrete interacting systems: 1) a bench of anonymous experts with reputation tokens in a variety of expertises, and 2) an open commenting forum for posted judgments. As used herein, a concrete system contains relatively static and permanent information as compared to a more dynamic system, a betting pool. A betting pool of reputation-staked bets from bench experts on forum posts intermediates between the two branches of the platform, determining expert reputation, and promoting productive work and specialization. The platform generates fees from public use. Fees are shared by bench experts through reputation tokens minted and staked in their name on evidence-of-work posts, which are evaluated by platform experts in the betting pool. Betting pool awards are paid out based on whether evidence-of-work posts show good work or bad work.

The described architecture benefits trade and business through a transparent, fair, and predictable system that facilitates certainty of outcomes, security, and efficiency. Society benefits from the advancement of justice and prevention of corruption on a global scale.

Techniques used in this platform are 1) to require all fees added to the system be shared with all experts, weighted according to reputation, and 2) all newly minted reputation tokens are staked as ½ upvotes and ½ downvotes on every evidence-of-work post which is subjected to review from experts in a betting pool. These protocols inhibit the power of buying reputation tokens while incentivizing productive work and the policing of counterproductive work.

There are two concrete structures which work together within the described platform: 1) a bench of anonymous experts with reputation in a variety of expertises, and 2) an open commenting forum for posted opinions, evidence of expertise, policies, evidence of work, and contract templates. Between the bench and the forum is the betting pool, a dynamic function where experts stake reputation on upvotes and downvotes on posts to determine experts' reputation, set precedent, and promote specialization and proficiency.

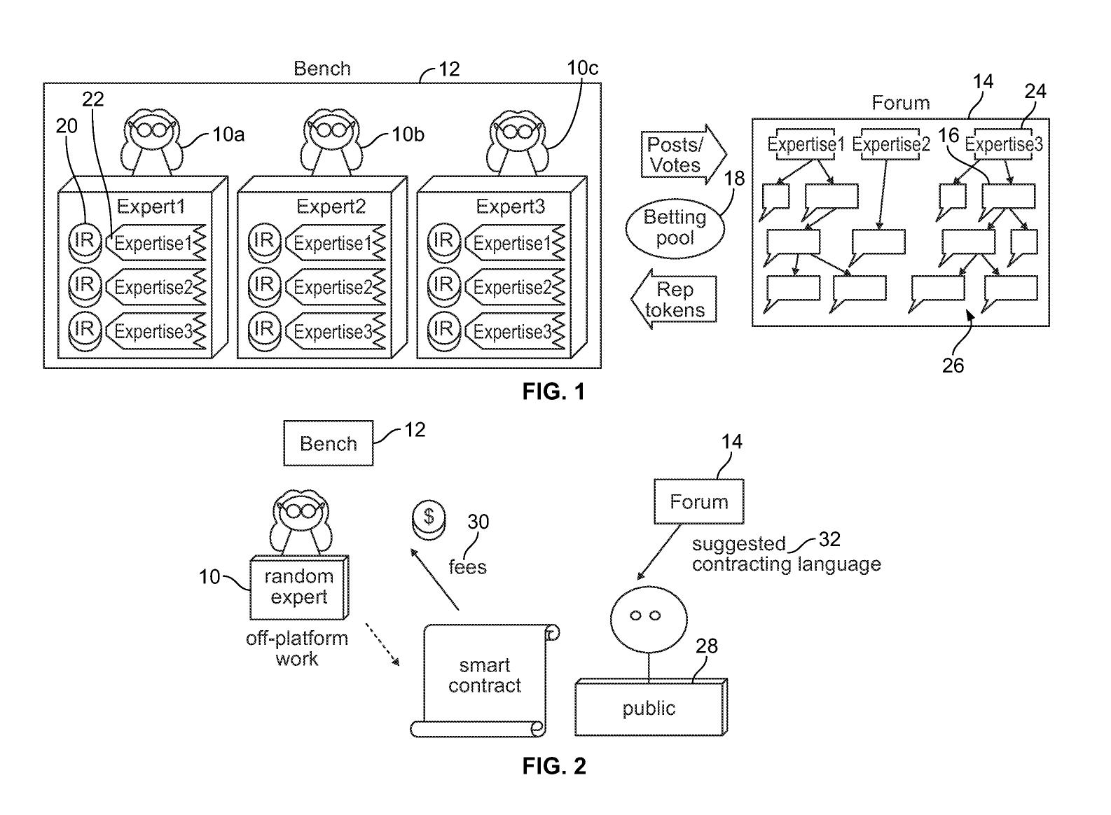

As shown in FIG. 1, the platform consists of a collection of experts 10a-c, called the bench 12, and an openly readable forum 14 which collects all evidence-of-work posts 16. A betting pool 18 mediates between the two, determining power, reputation, and precedence in the system.

The bench 12 of experts 10 is a database holding a record of all users who hold reputation tokens 20 (defined below) in various expertises 22. The forum 14 is a database of posted comments 16 from experts. Mathematically, the organization of the forum is a forest, i.e., a disconnected graph whose connected components are trees. The posts are the trees' nodes and an edge between posts is a pointer to a previous post's address. Posts without pointers to previous posts are the roots of each tree 26 in the forum; these roots are called expertise tags 24. An expertise tree 26 will also be referred to as an expertise or an expertise tag.

Within the forum 14, a graph is defined as a set of nodes (in this case the posts 16) connected in pairs by edges (in this case pointers between posts). A path is an alternating set of nodes and edges in a graph. A tree is defined to be a graph where every node is connected to a special node (called the root, which in this case is the expertise tag) by a unique path. A forest is a set of trees.

Every new post 16 in the tree 26 of a particular expertise tag 24 is subjected to the betting pool 18, where experts stake reputation tokens (defined below when we explain their creation) from that expertise tag 24 to upvote or downvote the post. The winners split the losers' stakes. Upvotes win ties. In one embodiment, all tokens within any particular expertise tag are identical, but each expertise tag has a unique token.

Non-expert users, called public users, can view the forum, and access the system by initiating smart contracts (expected to be developed in the forum) with currency fees which call experts from the bench to do work off platform.

As illustrated in FIG. 2, public users 28 access the system by calling experts 10 from the bench 12 to perform off-platform work by sending fees 30 to the platform. Public users 28 will find successful smart contracting language 32 for achieving such aims in the forum 14, as supplied by the bench experts who develop the forum in order to earn reputation.

Fees from the public are paid to the platform, not the individual experts called. These fees are split as salaries amongst all the experts, weighted according to their holdings of expertise tokens. The individual expert who does the off-platform work will post evidence of their accomplishment to be rewarded through the betting pool 18 with reputation tokens if their work is approved by the bench experts. In one embodiment, a portion of fees is paid directly to the expert doing the off-platform work and another portion is inserted into the system and converted into tokens as described.

Whenever a fee is paid to the platform it is associated with a new post in the forum 14. The new post is in the tree of a particular expertise tag 24. The platform mints new reputation tokens associated with the relevant expertise tag proportional to the amount of fees. In one embodiment, new tokens are created on a 1:1 ratio to the fees paid. Half the new reputation tokens are staked in the poster's name as a bet that the post improves the expertise. The other half of the newly minted reputation tokens are staked against the post. Specifically, in an example where the platform is implemented on Ethereum, separate ERC-20 tokens are minted for each expertise tag. We suggest the currency symbol XRP-EName for the reputation token associated with an expertise named EName.

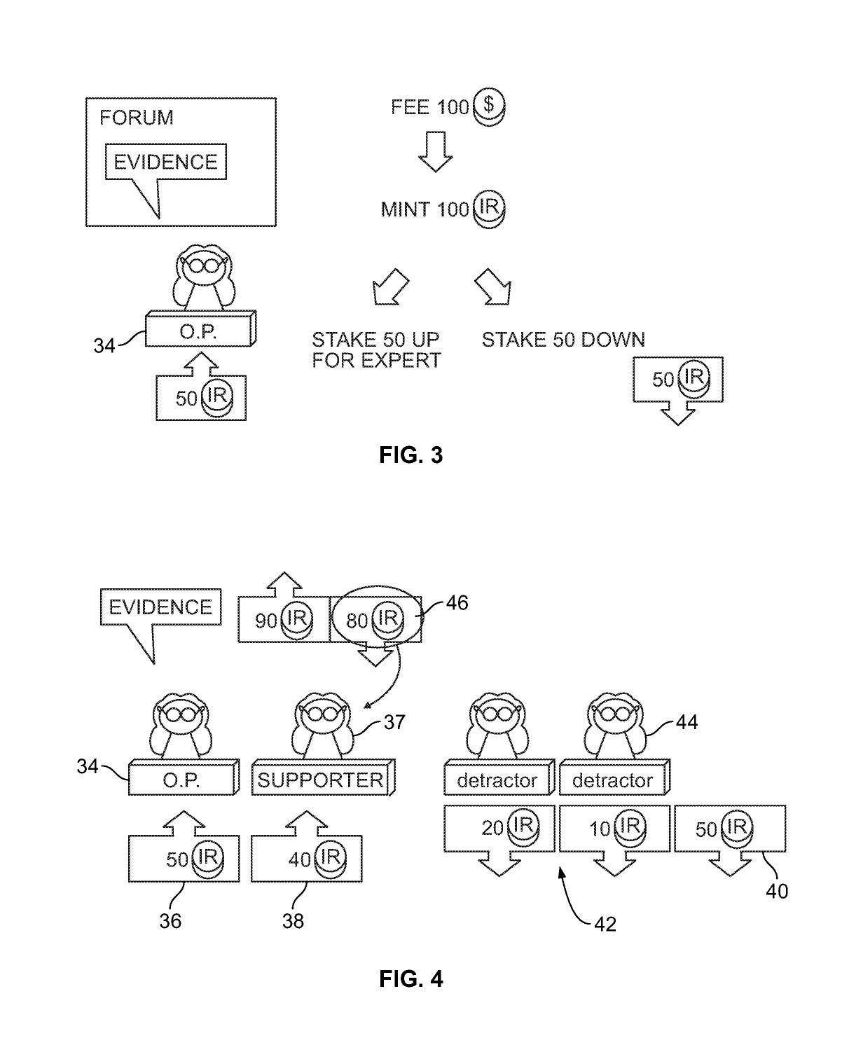

As illustrated in FIG. 3, all fees paid to the system are split amongst all experts, weighted according to their token holdings, in a reputational salary. Individual experts who do the work that attracts the fees are paid indirectly with reputation tokens if their evidence-of-work post is accepted by a weighted majority of experts. The original poster (O. P.) sends their post to the forum associated with the fee. The platform mints new reputation tokens proportional to the fee. One half of the newly minted tokens are staked for the O. P. as an upvote, ½ are staked as a downvote, then the rest of the experts are allowed to evaluate the post and participate in the betting pool. The post is then subjected to the betting pool for evaluation by the experts who stake reputation for or against the work. Winners split the losers' stakes.

FIG. 4 illustrates an example in which the upvotes on the evidence-of-work post win with 90 tokens against 80 staked as downvotes. The original poster's 34 (O. P.) newly minted fifty tokens 36 added to a supporter's 37 forty tokens 38, against the fifty newly minted downvote tokens 40 added to thirty tokens 42 cast as downvotes by detractors 44. The losers' eighty tokens 46 are split between the O. P. 34, who receives 50/90ths of the 80 lost tokens, and his supporter 37, who receives 40/90ths. Then the post holds a record of how popular it was amongst experts to determine the post's power as precedence.

The platform in one embodiment is defined above, by the relationship between the bench of experts, the forum of posts, expertise tags, the public and fees and salaries, reputation tokens and the betting pool. We now consider the consequences and practical function of the platform.

The forum will serve as a testing ground and evolutionary ecosystem for proving good practices within each expertise. In particular, to encourage public use of the expertise, smart contracting template code should be suggested by experts and continually subjected to the improving process of critical comments. Policies, evidence of experience, evidence of successful work, and advertisement for services will also be continually added to the forum.

To become a new expert, a public user posts a comment in the forum with a pointer to a previous post in the expertise and adds a fee in their own name. Following the protocol for whenever a fee is added to the platform, new tokens in the expertise tag are minted. Half the new tokens are staked for the new expert; half are staked against. Experts evaluate the post by staking their reputation in the betting pool. If the new expert's comment wins, the new expert is vested by the betting pool with reputation in the expertise linked to their pseudonymous public key identifier. If the comment loses, the new expert loses all their reputation in the expertise and returns to the public.

To create a new expertise tag, a public user posts a new root comment in the forum and adds a fee in their name. The system then follows protocol, automatically vesting the original poster with reputation in the new expertise tag. Specifically, new reputation tokens are minted in the amount of the fee chosen. Half the new tokens are staked for the poster; half are staked against. Since no other experts exist to evaluate the post, the poster's comment wins the tie, and the poster is vested by the betting pool with reputation in the expertise. This original expert is then free to add further posts, improving the expertise tag to encourage new experts to join and attract public fees.

The economics of the platform is simple. All of the currency added to the platform comes from fees from public users submitted associated with a post. All currency taken from the platform goes to experts through reputation-weighted salaries.

Contract fees and the method of expert selection are decided by the smart contracting parties. Whether the work requested in a smart contract is accepted is decided by the experts selected. The means for successful cooperation between the public and experts will evolve with continually improving smart-contracting language in the forum, such as appropriate fees and standards of work.

The platform does not require specific smart contracting language, simply a fee associated with a post. However, the platform was designed to thrive if the following choices are included in all smart contracts:

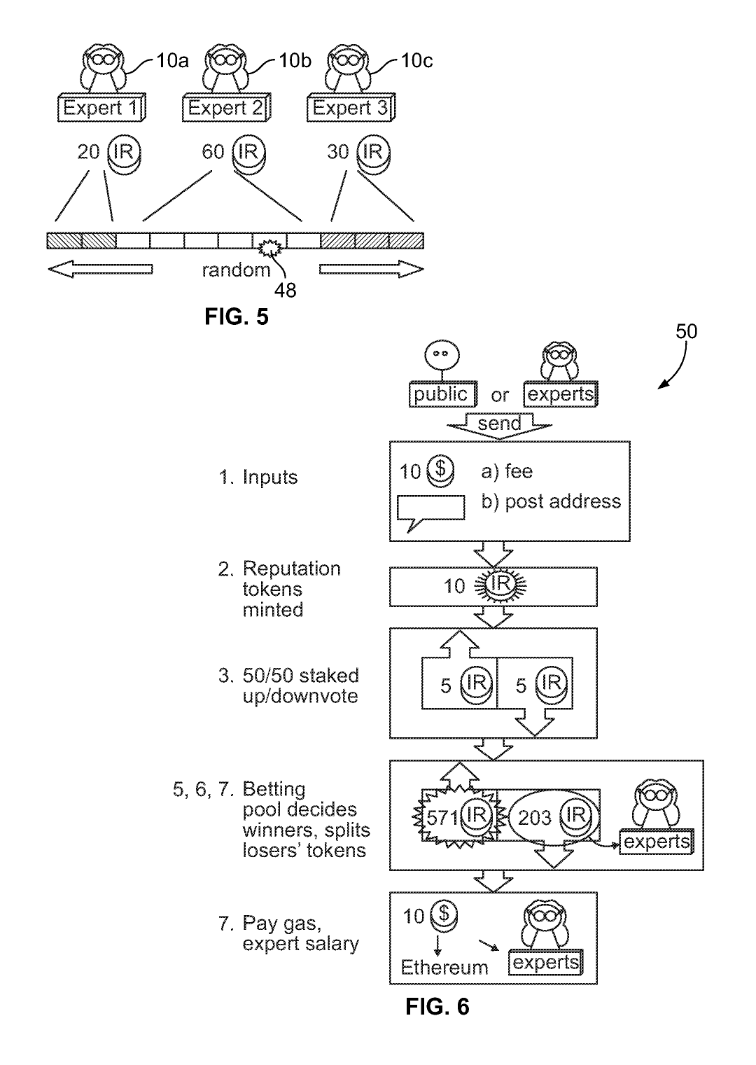

a) random selection of experts, weighted by reputation (see FIG. 5) experts should signal their availability by staking reputation tokens (called an availability stake) to determine their likelihood in the random selection

b) this availability stake should automatically be added to the expert's evidence-of-work post as the expert's upvote stake in the betting pool

c) experts should not be given the fee directly, instead they should be given the power to post evidence of their work to the forum with the fee in their name.

As illustrated in FIG. 5, random selection of experts 10a-c is decided by relative weight of reputation. Before a smart contract is engaged, experts have the opportunity to stake reputation tokens to signal their availability for work. These tokens are called availability stakes, and will be added as the chosen experts' upvote bet on their evidence-of-work post. In this example the star 48 stops randomly along the bar, but is most likely to stop on the 2nd expert.

For the healthy development of the platform, public smart contracting parties are expected (but not required by the platform) to choose to add such stipulations to their smart contracts to engage work from the platform. They are expected to do so because evidence is posted to the forum that such measures achieve the relevant goals. But the platform does not technically require any of these measures. To function, the platform merely requires a fee associated to a post.

To further explain item “c” above, a smart contract is written engaging an expert, the smart contract should specify that the chosen expert is given the power to write the work-evidence post submitted for evaluation to the expertise tag, with the fees posted in the chosen expert's name. The system is completely open, and nothing stops smart-contracting parties from engaging its experts directly. However, using the system as designed gives public parties insurance. By writing the contract so that first, the expert stakes some of their reputation on the outcome with an availability stake, and second, the expert is given the power to add the fee to the platform in their name for evaluation by the other experts, the public can be certain there is a strong incentive for the expert to produce good work.

In review, experts from the bench stake their reputation tokens to 1) write posts, 2) evaluate posts with upvotes or downvotes, and 3) announce their availability for working public smart contracts by posting stakes of their reputation. The forum evolves to include information on 1) proper smart contracting language for the public to use to engage experts, including appropriate fees and protocols for work, 2) policies for the future development of the expertise tree, and 3) reputation-verified evidence of expertise through posts of successful work. The betting pool intermediates between the bench and the forum to vest experts with bet-verified reputation, which is valuable as power to influence the development of the expertise tree and valuable in gaining future reputational salaries.

With these solutions the platform may automatically scale to be able to handle any type and value of work. In the next section we discuss the problems the platform solves, then give an example Ethereum instantiation.

### Attack Resistance

The described system provides an attack-resistant platform architecture. Traditionally, the most dangerous attacks on reputation-based decentralized autonomous platforms have been Sybil attacks and tyranny of the majority. In this section we discuss how embodiments of the present system inhibit these attacks. How the system inhibits further types of attacks is discussed below.

a) Sybil Attacks

Simple Sybil attacks consist of any anonymous single user opening any number of expert accounts to use worthless automated work in order to unjustly profit from the system. The described platform is Sybil attack resistant because all power in the platform is weighted by reputation which creates little advantage for any particular user.

The power of reputation in the platform has 3 uses: being chosen as an expert for off platform work, voting on posts, and salaries. All of these actions are unaffected or weakened by spreading reputation between accounts. Thus, simple Sybil attacks are completely inhibited.

Since fees are paid indirectly as salaries, the platform encourages development of reputation. Since all newly-minted reputation tokens join the platform as 50/50 up- and downvote bets, there is no opportunity to overwhelm the system with outside power, since established experts always have complete power to determine whether new reputation is given to a user. Thus reputation is only ever vested to those who can prove their contributions improve the platform to existing experts.

b) Tyranny of the Majority

Another significant threat to fair and just decision-making in an anonymous and democratic reputational system is the potential for tyranny of the majority. Alexis de Tocqueville coined the term tyranny of the majority in order to describe the corruption in a system that manifests itself in decisions made with a greater concern for following what is perceived as popular than what is right and just.

However, many of the problems with the tyranny of the majority are avoided with a weighted voting system. In this case greater power generally accrues to those with greater expertise. Then voters will be concerned with voting in line with powerful experts, which generally favor precedent and predictability.

The second mechanism that counters the tyranny of the majority is the time-delay in announcing the results of upvotes, so experts cannot plainly see the majority position before posting their stake. Finally, any expertise tag which is corrupted will not attract fees, and it is easy to create a competing expertise tag to replace it.

c) Reputation Calculation

Here we demonstrate the attack resistance of the platform by showing that in the worst-case scenario, the price to corrupt the system is twice the total historical fees added to the system. If any of the recommended protections discussed above are instituted, the price to corrupt grows steeply.

Consider the situation where the platform has a total of g₀ reputation tokens at time 0. We will refer to all these users as good-faith experts. Imagine a malicious group m wishes to purchase 51% of the reputation with fees, either to profit from future transactions or to destroy trust in the particular tree. Since only half of their fees are added as reputation tokens for the malicious group, and the other half will be added to the existing good-faith actors it is difficult to achieve the malicious goal, even in this worst-case scenario.

Under the worst-case scenario, we suppose there are no safeguards against joining as an expert—any fee of any size is automatically accepted in the betting pool, and resolved instantly with no time delays. Finally we assume no other users are adding any fees.

Under this scenario, the best strategy for the malicious group to gain reputation by paying fees is to make many micro-payments. In the same way that continuously-compounded interest is better than discrete interest at the same rate, micro-payments allow malicious users to profit off their own later fees once their earlier fees vest them with reputation.

Thus we assume the malicious group m will add a variable number n of fixed fees of size Δx<<1. Then the good faith experts will have

$${g}_{n + 1} = {g}_{n} + \frac{1}{2} Δ x ( \frac{{g}_{n}}{{g}_{0} + n Δ x} )$$

reputation after n+1 fee payments from the malicious users, with g₀ being the initial reputation of the platform, while the malicious user will have

$${m}_{n + 1} = {m}_{n} + \frac{1}{2} Δ x ( \frac{{m}_{n}}{{g}_{0} + n Δ x} ) + \frac{1}{2} Δ x$$

reputation tokens, with m₀=0. Therefore

$$\frac{Δ {g}_{n + 1}}{Δ x} = \frac{1}{2} ( \frac{{g}_{n}}{{g}_{0} + n Δ x} )$$

which becomes the Ordinary Differential Equation (ODE):

$$\frac{dg}{dx} = \frac{1}{2} ( \frac{g}{{g}_{0} + x} )$$

as Δx→0. Similarly

$$\frac{dm}{dx} = \frac{1}{2} ( \frac{m}{{g}_{0} + x} ) + \frac{1}{2}$$

We want to know how many fees x are required before the malicious group can overwhelm the system with 51% reputation power, so we solve g(x)=m(x).

Solving the ODEs using the method of integrating factors gives the formulas

g(x)=\sqrt{g₀²+g₀x}

and

m(x)=x+g₀−\sqrt{g₀²+g₀x}

So m overwhelms the system once x=3g₀.

However, while the malicious users are paying the fees, they are also receiving salary payments that are increasing as they gain reputation. While paying the 3g₀ in fees, the total salary regained by the malicious group is

$${\int }_{0}^{3 {g}_{0}} \frac{m ( x )}{m ( x ) + g ( x )} dx = {g}_{0}$$

Consequently the malicious group would need to invest an absolute minimum of 2g₀, that is, double the total reputation of the system to gain 50% power in the system in order to outvote the rest of the good-faith experts in the betting pool.

We stress that the value of 2g₀ is an extremely conservative lower bound. In practice, the investments would need to be discrete values, not continuous. This significantly raises the minimum corrupting investment, and significantly lengthens the time needed to gain 51% power. Also, in practice many other users will be paying fees besides the malicious group, especially if the malicious group is pumping fees into the system.

Assuming the malicious group does manage to take over the platform, the rest of the world would immediately see the unfair action that couldn't be rectified by the good-faith actors, so the platform would topple. The malicious group would merely gain the (fraction) of the fee from one transaction. As long as any single fee is smaller than the total reputation, there is no incentive to game the system for fees.

The only other reason to act maliciously is to destroy the platform. But then the 2g₀ invested becomes worthless. So the minimum cost at any time to topple the system is twice the total reputation tokens—assuming you can simply buy reputation without limit or oversight.

Therefore as long as the fees are low compared to the reputation total, or if there is no competitor that is suffering by the platform's existence by more than twice the total number of reputation tokens, it's not worth spending money to corrupt the system—it is more valuable to use the power to improve the platform.

Further, as fees are added, reputation is added, so it becomes more secure as time goes on, even assuming constant fees.

Further, if a malicious group wishes to strike, their best strategy is to strike immediately. Their corrupt reputation tokens become less valuable if they don't use them, as each new fee they didn't add to the system adds to other peoples' tokens, diminishing the value of older tokens. So even if there are many different malicious groups, if no single malicious group gains 51% control, the system cannot be corrupted to unfairly earn fees.

A malicious group is therefore limited to attempting to destroy the platform, by overwhelming it with fees. If that is happening, and there is a reasonable time-delay in resolving betting pools, then the incoming malicious fees would encourage other, non-colluding parties to invest as well. This would significantly slow the effort to gain 51% for the malicious group.

Specifically, assume the good-faith experts invest some constant fraction c of the malicious groups' investment Δx at each time. If c≥1 then the malicious group will never gain more than 50% power. So assume 0<c<1. Then the equations become

$$\frac{dg}{dx} = \frac{1}{2} ( 1 + c ) ( \frac{g}{{g}_{0} + ( 1 + c ) x} ) + \frac{1}{2} c$$

$$and$$

$$\frac{dm}{dx} = \frac{1}{2} ( 1 + c ) ( \frac{m}{{g}_{0} + ( 1 + c ) x} ) + \frac{1}{2}$$

which are solved to give

$$g ( x ) = \frac{\sqrt{{g}_{0} + ( 1 + c ) x}}{1 + c} ( c \sqrt{{g}_{0} + ( 1 + c ) x} + {g}_{0}^{1 / 2} )$$

$$and$$

$$m ( x ) = \frac{\sqrt{{g}_{0} + ( 1 + c ) x}}{1 + c} ( \sqrt{{g}_{0} + ( 1 + c ) x} - {g}_{0}^{1 / 2} )$$

Then the solution to g(x̅)=m(x̅)

$$\overline{x} = [ \frac{4}{{( 1 - c )}^{2}} - 1 ] \frac{{g}_{0}}{1 + c}$$

is the total amount the malicious group m must invest, and they recover

$${\int }_{0}^{\overline{x}} \frac{m ( x )}{m ( x ) + g ( x )} dx = \frac{1}{1 + c} ( \overline{x} - \frac{2 {g}_{0}^{1 / 2}}{1 + c} [ \sqrt{{g}_{0} + ( 1 + c ) \overline{x}} - \sqrt{{g}_{0}} ] )$$

of those outlays through reputational salary. So the final cost to override the system when good-faith experts are investing the fraction c of the malicious investment is

$$[ \frac{4}{{( 1 - c )}^{2}} - 3 ] \frac{{g}_{0} c}{{( 1 + c )}^{2}} + \frac{2 {g}_{0}^{1 / 2}}{{( 1 + c )}^{2}} \sqrt{{g}_{0} + ( 1 + c ) \overline{x}}$$

For instance, if the malicious group is doubling the investment of the rest of the community, then c=1/2 and

x̅=10g₀

of total reputation must be spent in fees, while more than

58/9g₀≈6.44g₀

will be lost.

We further discuss the consequences of these calculations in the discussion of proof of stake.

The platform offers an infrastructure of checks and balances that inhibits system corruption by incentivizing productive contributions to the platform and dis-incentivizing malicious conduct.

Combined with the platform's two concrete branches,

1) the bench of experts

2) the forum

the off-platform third branch of the system consists of

3) the public smart contracting parties.

These three branches and their process of interaction entail a cyclical system of checks and balances which combat corruption and encourage healthy development of the platform and crypto economy.

The branches check each other as follows: Between the bench and the forum, experts are incentivized to improve and police the forum, or else no fees come from the public. The public is incentivized to use the correct contracting language from the forum, or else the bench experts will not accept the public's calls for work. Experts from the bench will try to successfully fulfill the needs of the public's call for work, or else the forum will punish the expert with loss of reputation stakes through the betting pool. Thus each branch checks the activities between the other branches, ensuring productive development.

The process of interaction between the branches is designed to be balanced. Since all newly minted tokens are staked 50/50 for and against the post and all losers' tokens are split by the winners, the system encourages careful and judicious self-policing. This 50/50 balance encourages unbiased and truth-seeking voting, since neither side is favored. Since all fees are split between reputation token holders, the entire incentive in the system is to acquire reputation, balancing the motivations of protecting the value of reputation in the expertise tag and earning new fees for the expertise tag. Finally since all fees that come into the platform are disbursed to the expert users and not any asymmetrically powerful outside owners of the platform, the system is internally balanced against outside corruption.

System Autonomy

Platform Maintenance

The platform achieves full autonomy almost immediately. For example, once the short Ethereum DApp detailed in the Practical Instantiation discussion, below, is posted to the blockchain, its authors have no more control over the evolution of the expertise trees in its forum than any other Ethereum user. Creation, hosting, and maintenance costs are borne entirely by users.

Parameter Maintenance

To improve efficiency, several parameters within each expertise tree can be regularly adjusted as the platform evolves. For example:

the minimum stake/fee for comments

the time given before the votes on a post are revealed and tallied

conversion rate between off-platform currency fees and reputation tokens

hosting decisions for evidence-of-work posts and contact between experts and public parties

The open commenting forum will have branches devoted to program improvement. The upvote system will provide ample decision-making mechanisms for debate and resolution.

The following mechanism gives experts the ability to adjust these parameters. The 1 day time limit for bet resolution explained above is completely arbitrary. The suggested mechanism for adjusting this time limit would conclude each betting pool early if all active experts have voted. An active expert is defined as an expert who has voted in one of the last 5 consecutive active pools. An inactive user becomes active as soon as they vote in any pool. To add stability, only one parameter change proposal can be active at any moment, and each proposal would have lower and upper bounds of parameter adjustment limited to halving or doubling their current state.

Reputational Meritocracy

The platform encourages efficient collaboration. The only rewards possible are received for expert-evaluated improvements to the platform. The system is designed to resist economic corruption and inefficiencies by fairly evaluating all work with the measured vesting of valuable reputation.

The forum is the environment where experts demonstrate their value. Experts gain reputation by posting and evaluating posts. Successful posts are comments in the forum which win the upvote betting pool. Winning the betting pool means the other experts evaluate the post and believe it improves the value of the tree. Types of posts include but are not limited to the following:

policies for future development of the tree

protocols for acceptable behaviour

evidence of experience

evidence of work

creating or improving smart contracting templates

criticizing any of the above

Upvotes naturally determine the strength of precedence set by each comment.

### Platform Economics

The platform is decentralized and autonomous. There is no centralized foundation which owns any part of the platform. So the economics is very simple.

All money into the system comes from fees paid by business access, and fees from commenters who post to become new experts. New commenter fees are expected to be smaller than outside business fees in the long term for healthy expertise tags; otherwise the expertise tag is simply a pyramid scheme.

All money out of the system is paid as salaries to experts according to reputation. All fees paid to an expertise tag are split between the experts weighted according to their relative holding of reputation tokens in that expertise tag.

Specifically, supposing expert Eᵢ has reputation in only one expertise tag, then their salary S(Eᵢ) is given by the formula:

$$S ( {E}_{i} ) := \frac{R ( {E}_{i} )}{{\sum }_{j}^{ } R ( {E}_{j} )} {\sum }_{k}^{ } F ( {x}_{k} )$$

where R(Eᵢ) is the total reputation tokens of expert Eᵢ so Σⱼ R(Eⱼ) is the sum of the reputations of all experts Eⱼ in the expertise tag, i.e., the total number of reputation tokens in that tag; and F(xₖ) is the fee paid that is associated with post xᵢ so Σₖ F(xₖ) is the total fees paid into the system allocated to that expertise tag during that pay period.

Experts with reputation tokens in several expertise tags are paid as specified above for each tag.

Thus, salaries are paid for many actions, including:

posting evidence of off-platform work for smart contract fees, commenting on work posts

creating and commenting on comments, policies, and expertise evidence

creating, criticizing, and improving contract language boilerplate

creating, criticizing, and improving platform parameters

Reputation Calculations

In this section we illustrate the value of one reputation token with calculations. This demonstrates the value of an investment in reputation in the platform without using its power.

One reputation token loses value if fees are constantly added in time.

If fees are constantly being paid into an expertise tag at a rate of F (t)=r units per time, then the salary paid for one coin decreases in time. To see this, denote the total number of reputation tokens in the tag at time t by T(t). The salary per token per unit time is S=F/T. However, since each fee token creates a new reputation token, we have

T(t)=T(0)+rt

so

$$S ( t ) = \frac{r}{T ( 0 ) + rt}$$

which shrinks to 0 as time goes on.

One Reputation Token Loses Value if Fees Grow Linearly in Time.

If the fees are given by F(t):=ct then the reputation recurrence relation R(t+1)=R (t)+F (t) can be solved to give

$$R ( t ) = R ( 0 ) + F ( 0 ) + ct ( t - 1 ) / 2$$

$$so$$

$$S ( t ) = \frac{ct}{R ( 0 ) + F ( 0 ) + ct ( t - 1 ) / 2}$$

Which Shrinks to 0 as Time Goes on.

One Reputation Token Pays Constantly if Fees Grow Exponentially in Time.

If the fees are given by F(t):=F(0)e^{ct} then reputation satisfies the recurrence relation R(t+1)=R(t)+F (t) which may be solved to give

$$R ( t ) = R ( 0 ) + F ( 0 ) \frac{{e}^{ct} - 1}{{e}^{r} - 1}$$

$$so$$

$$S ( t ) = \frac{F}{T} = \frac{F ( 0 ) {e}^{ct}}{R ( 0 ) + {F ( 0 )}^{{e}^{ct} - 1 / {e}^{r}} - 1} \to {e}^{r} - 1$$

$$as t \to ∞ .$$

Early Reputation Tokens are More Valuable than Later Tokens.

All reputation tokens in a single expertise tag are equal at any given moment. However, assuming a steady state rate of fees, the payout for 1 year from inception is greater for tokens minted earlier, because later tokens are a smaller percentage of the total. Remember new tokens are created with every fee paid into the platform, but never destroyed.

This may mean later experts have less motivation to join if fees paid into the system are at a steady state. Potentially this could result in a diminished labor force that cannot handle all the fees directed to the expertise, which would damage the value of the expertise tag. To combat this, the bench may choose to change the exchange rate between fees and reputation tokens to encourage new recruits.

Practical Instantiation

In this section we detail one possible approach to implementing the platform on a specific network, Ethereum.

1. Ethereum

On the Ethereum network, the platform is instantiated as a decentralized application or DApp. The platform's DApp includes a betting pool similar to Augur and Gnosis, but differs significantly in how ether fees and tokens are handled.

The platform's DApp is described in the following pseudocode algorithm:

1. Accept two initial inputs:

a) an Ethereum transaction's address.

##This transaction will become a new post in the forum. It may include a pointer to a previous post in the forum, in which case the post is associated with an established expertise tag, which is the root post in the tree determined by the pointers. If no pointer is included, it is a root post and therefore a new expertise tag. An expertise tag is simply the address of the Ethereum transaction that is a root post, but it will also have a human readable name such as E500. If a pointer is included, the post is a new leaf on an existing expertise tree.

b) An Ether Fee.

2. Mint new reputation tokens in the relevant expertise tag equal to the number of ether in the fee. ##For example, if the human readable name of an expertise tag is E500, the newly minted tokens in E500 will be ERC-20 tokens of the type XRP-E500.

3. Stake half the new reputation tokens in the poster's name along with the other optional reputation tokens the poster sent as an upvote bet. ##Stake the other half of the newly minted tokens against the post as a downvote.

4. Broadcast the opening of the betting pool to the network. ##This means the address of the post (and automatically, therefore the relevant expertise tag) is broadcast with a 1 day deadline for submitting relevant reputation tokens as upvotes or downvotes on the post.

5. Collect, count, and compare the upvote and downvote reputation tokens to decide the winner.

6. Publish the result and distribute the reputation stakes from the losing side to the winners, weighted according to stakes.

7. Distribute the remaining ether fee (after paying necessary gas) as the reputational salary to all owners of the reputation tokens in the expertise tag, weighted according to their holdings.

FIG. 6 illustrates a platform flowchart for an Ethereum DApp pseudocode.

In this particular proposed Ethereum instantiation of the platform, the Ethereum blockchain is used to hold the text posts eternally, which is not always necessary or preferred, especially if the posts contain a large amount of data or information compromising to privacy. Such posts may instead refer to off-chain information which is more economically stored and better protected.

Notice the Ethereum ether fees (gas) required to make any post automatically inhibits DoS attacks.

Also notice there is no superstructure in this instantiation which organizes the expert accounts in an official bench, nor is there a superstructure which organizes the forum of posts. The database holding the experts' tokens and posts is the Ethereum network itself. Separate systems are expected to be developed outside the platform in order to improve access to the information and facilitate its use, similar to how private companies provide wallets for ether or bitcoins.

Many protocols for healthy expertise tag development are not hard coded and therefore not technically required, as stressed in the previous section. Such recommendations are actually choices decided by contracting parties by including the relevant smart-contracting language suggested in the forum, and by the experts when they agree to do the work posted in their expertise tag in the forum. We strongly suggest parties and experts choose the following protocols:

a) experts are chosen at random

b) chosen experts are given the power to post and add their fees to the system

c) experts submit availability stakes by using reputation tokens which weight the random choice and are automatically added to their evidence-of-work post

d) the Ethereum transaction from step 1 of the algorithm is a text post comment intended for the forum

For the healthy development of the platform, smart contracting parties are expected (but not required by the platform) to choose to add such stipulations to their smart contracts to engage work from the platform. They are expected to do so because evidence is posted to the forum that such measures achieve the relevant goals. But the platform does not technically require any of these measures. To function, the platform merely requires an ether fee and the identifying number of an Ethereum transaction as inputs.

Two important parameter choices were made arbitrarily in this instantiation: first, the conversion rate of 1 ether to 1 token; and second, the time to resolve a bet as 1 day. Adding a mechanism whereby majority bets give experts the ability to adjust these parameters gives them much more power. The suggested mechanism would conclude each betting pool early if all active experts have voted. In one embodiment, an active expert is defined as an expert who has voted in one of the last 5 consecutive active pools. An inactive user becomes active as soon as they vote in any pool. To add stability, only one parameter change proposal can be active at any moment, and each proposal would have lower and upper bounds of parameter adjustment limited to halving or doubling their current state.

Other Networks

The architecture for the platform was created to be effective in a hostile open environment containing malicious anonymous actors. It is more effective in a centralized system with identified participants where the blockchain is not necessary and its inefficiencies can be avoided.

Third-Party Functions

Separate, off-platform entities will emerge to provide systems for connecting users with the platform. These entities may or may not be private, for-profit companies. They will provide solutions for improving human factors and ergonomics for public and expert users, such as user interfaces for interacting with the forum and engaging smart contract templates without the need for users to personally code smart contracts. These off-platform entities will organize the information created in the platform, such as editing the comment forum to be relevant to their particular users, suggesting work for experts outside and inside the platform, and streamlining education in obtaining experience and reputation with the platform.

Summary

The platform vests experts with verified reputation. The platform provides three systems: 1) a database of experts' anonymous accounts, including their history and reputation, 2) a commenting forum for posting evidence of work, criticisms, policies, and smart contracting language suggestions, 3) a betting pool upvote system for allocating reputation from each expertise tag.

The smart contracts are created by public users outside the platform, and therefore choose their own language for employing the platform. Public users control all contractual choices, including deciding which types of expertise are required from the bench, what fees are paid to the system, and how experts are called. Experts decide whether such fees and work are acceptable. The forum mediates between the two.

The commenting forum will also be a testing ground for improving smart-contracting language via the upvote process. Smart contracting parties will freely use the forum to choose the appropriate smart contract for their needs. Successful language will evolve via the criticism of actual and hypothetical contracts.

The upvoting system is a betting pool, where experts stake percentages of their total reputation to up- or downvote posts in the forum. The winners divide the losers' stakes, enriching their reputation.

Reputational tokens are minted in the system with each fee paid by the public, proportional to the fees paid by the smart contract. These tokens are automatically staked 50/50 on up- and downvote bets on the associated posts and distributed to the experts through the betting pool.

Fees paid by smart contracts employing the platform are distributed to all experts in salaries weighted by reputation.

Combined with the platform's two concrete branches, the bench of experts and the forum, the third branch of the system consisting of the public smart contracting parties entail a system of checks and balances which combat corruption and encourage healthy development of the platform and crypto economy.

The system automatically scales to valuate any type of expertise with verified and regulated reputation.

### EXAMPLES

To aid the imagination, this section details some of the expertise trees that will be developed in the forum.

First we discuss how a general expertise is developed by arbitrarily choosing carpentry to illustrate how experts can organize and cooperate to attract public fees for their work. Second, we give a more detailed illustration of how dispute resolution can be achieved for general smart contracts in an expertise tree we call Distributed Jurisdiction. This expertise tree will be invaluable to the evolution of the platform, as it will give users confidence their smart contracts will perform as expected. Third, we show how an entire company can be organized on the platform. We also give examples of how the platform is capable of hosting automated work and serving as an oracle that verifies and integrates the performance of off-network events.

### Example: Carpentry

Consider the example of a carpenter, Adam, who would like to add a carpentry expertise tag to the system.

Adam uses cryptocurrency to create the expertise tag. Being vested with reputation tokens, Adam continues to make comments in the carpentry expertise tag tree, elucidating policies and advertising to attract further experts to join the expertise.

Next Betty applies to gain carpentry reputation tokens by posting evidence of her skills and work with a cryptocurrency stake. Adam evaluates Betty's posts and decides whether to allow her to join. If successful, Betty gains reputation tokens which she can use to contribute to the carpentry expertise tag by:
evaluating future applicants
improving the carpentry forum by adding and improving
policies
evidence of expertise
smart contracting templates for engaging the services of the bench of experts
advertising to outside parties
and posting her availability for work

In a similar way collaborations for any purpose can be formed on the platform, by creating evidence of their expertise on the forum, collecting experts and vested employees in the bench, establishing reputation through the betting pool, and collecting fees through smart contracts from outside the platform.

### Example: Smart Contract Dispute Resolution

In this section, we detail an important application of the platform, dispute resolution in the distributed and anonymized environment of the crypto economy. We call this application of the platform Distributed Jurisdiction (DJ). DJ illustrates how several expertise trees in the forum can work in parallel, as smart-contracting parties will typically require several skills from their arbiters, as detailed below.

Bench experts in the dispute resolution expertise tags will be called arbiters in this section.

To use the Distributed Jurisdiction platform, public users choose their own smart contracting language. Therefore, the protocols of dispute resolution are entirely determined by the contract parties as stipulated by the smart contract at the point of creation.

Successful smart contract language is expected to be developed through the evolutionary process driven by the betting pool in the forum. The protocols suggested in this section are therefore entirely hypothetical.

Contract Creation

When a smart contract is created, the means of dispute resolution is included before parties sign.

Break Clause

A break clause in the smart contract will transfer to a 3rd party arbiter the complete power to disburse the encumbered assets of the smart contract between the parties. The break clause is triggered whenever either party chooses to initiate a dispute.

3rd Party Arbiter

Distributed Jurisdiction is designated as the platform for dispute resolution of smart contracts by including a 3rd party arbiter in the respective smart contract—an open position for a randomly selected expert from the bench whose power is triggered when a contracting party initiates a dispute. The arbiter's power to disburse the assets of the contract between the other parties, once triggered, should be preeminent in order to ensure certainty of outcomes.

Before being selected to adjudicate any case, each arbiter posts an availability stake. This is a number of their reputation tokens that will be included as the arbiter's upvote bet on their final post justifying their eventual decision on the case.

An arbiter is randomly selected, weighted according to availability stakes posted and according to the expertise tags specified by the contract. These tags decide values assumptions for the contract. Expertise tags signal the type of dispute and indicate the experience required of potential arbiters. Examples of expertise tags include relevant areas of law (property, employment, Delaware corporate law, etc.), technical matters disputed, languages, territorial or cultural assumptions, and anonymity level.

Fees

Fees are determined by market factors at any given point in time. Fees are calculated based on the availability of relevant arbiter availability stakes. Arbiters specify the fees they will accept for each reputation token staked, the availability stakes, by advertising in the forum. Preferably, the platform does not dictate the fees.

If the fees chosen by the contracting parties are insufficient the arbitration will fail as the arbiter selected will refuse to do the work. If the arbiters require fees higher than the public is willing to pay, they will fail to attract cases.

The smart contract should specify that the fee is sent in the arbiter's name to the Distributed Jurisdiction platform associated to the arbiter's judgment post in the forum. The fee is not sent directly to the arbiter, or else the parties are not technically using the Distributed Jurisdiction platform.

The reason the parties will prefer to send fees to the platform instead of the arbiters directly is the insurance provided by the evidence-of-work post which only rewards the arbiter if other arbiters approve of their decisions.

Arbiter Chosen

A random arbiter is chosen based on availability, expertise, reputation, and fees. Before the choice is made, all arbiters from the pool have submitted a stake signaling their availability, and the forum has advertised protocols and fees the arbiters will accept for dispute resolution work. The arbiter's availability stake is a number of their reputation tokens, chosen from each of the expertise tags they've improved.

Then the system takes the weights that the contracting parties chose for each expertise tag (summing to 100%) and multiplies these weights by the available users' weights to determine the likelihood of each arbiter being picked. Using this distribution, the arbiter is randomly chosen from the pool of arbiters.

As an example, imagine there are 3 expertise tags in the contract, which the parties chose as 50% English speaking arbiter, 25% intellectual property law, 25% corporate law expertise. Next suppose arbiter A has 10% of the available reputation tokens staked from the entire bench in English, 5% of the intellectual property, and 7% of corporate law expertises. Then (0.5)(0.1)+(0.25)(0.05)+(0.25)(0.07)=0.08 so arbiter A has an 8% chance of being selected for the dispute by the system.

Once chosen, the arbiter has the power of disbursing the assets of the contracts as seen fit between the disputants. Asymmetry in party asset encumbrance may be abused if assets from each party are encumbered equally. However, the arbiter also has the power to combat such abuses by choosing at any point to release a portion of the property to either party before the judgment is complete, based on temporal concerns.

The arbiter's stake also represents a bet that the community will agree with their decision. An arbiter's stake is combined with the half the contract fee as the arbiter's upvote bet on the post of the decision, half the fee is staked as a downvote against the bet. This encourages direct participation of arbiters in the adjudication portion of the platform.

Private Hearing

A private hearing is initiated with the arbiter as moderator. This hearing takes place entirely off platform, following the protocols set by the smart contract. Solutions for how to perform the hearing will be decided as protocols evolve in the forum.

One possible approach for the beginning of the platform is detailed as follows. Symmetric encryption (PGP, e.g.) guarantees efficient, anonymous communication between the parties and arbiter using their asymmetric public-key identifiers. Then the trial proceeds as follows:

1) Plaintiffs submit their case, including proposed settlement.

2) Defendants submit their rebuttal, including proposed settlement.

3) Arbiters ask open questions until deciding to close the question session.

4) Arbiters repeats 1)-3) until choosing to close the trial.

Standard procedure small asset contracts may have an arbiter ask no questions and deliver a verdict after step 2 by quickly explaining the relevant precedent. Standard procedure for larger contracts may involve several rounds.

Judgment Posted

The decision of the arbiter is posted to the forum, with official spaces for comments by the claimants. The arbiter can only benefit by increased reputation if the post wins in the upvote betting pool.

Justice Mining

The posted judgment is viewable by the pool of arbiters in perpetuity in the forum. Comments praising and criticizing judgments will serve as a record of precedence in the system. Comments live as records of votes eternally, but the system allows for review of comments by reposting the same or similar comments further down the branch for a new, potentially more decisive vote, allowing further confirmation of a precedent or the possibility of overturning it.

The system employed to encourage careful adjudication is the betting pool. Arbiters stake a percentage of their reputation on an up- or downvote. After 1 day of voting the results are revealed and the winners of the decision (upvoters or downvoters) split the losers' stakes, weighted according to their bets. This method determines justice with a democracy weighted according to expertise and encourages effort in discernment of truth.

There is an obvious threat to the anonymity of parties and arbiters in any adjudication process which requires information to be exposed during arbitration and the judgment post. This threat is minimized by good practices in adjudication, such as the use of highly standardized template language which will develop in the forum.

Appeals

The rules of the appeals process are encoded in each individual smart contract. Therefore the specifics of the process will evolve as best practices are discovered in the comment section and upvoted. In this section we detail one possible scenario.

If an appeal is triggered by a claimant within the designated statute of limitations, a second hearing is initiated. A much higher stake is posted by the appellant to restrain frivolous abuse of resources. A panel of 3 arbiters is randomly selected, and power to disburse the assets is transferred from the original arbiter. In this case the only variation in the hearing is to repeat the question phase, Step 3), with the 3 arbiters asking questions, in order, according to reputation.

When a majority of arbiters choose to close the hearing, a private conversation between arbiters is initiated to settle the dispute. When a majority of arbiters choose to close the private conversation between arbiters, a binary vote between claimants is cast. The arbiter with the greatest reputation in the majority opinion writes and posts the judgment, with space available for dissenting opinions.

A second and final appeal is possible, within the contractually specified statute of limitations, which repeats the process with 9 randomly chosen arbiters and a higher stake posted by the appellant.

As stressed previously, ultimately the type of appeal process is always determined by the parties of the smart contract at the point of signing. As the Distributed Jurisdiction platform matures, standards for statutes of limitations will evolve determined by the jurisdiction related to the relevant expertise tags. Similarly, the very process of appeals may vary depending on subject matter. For example, large disputes with less concerns for privacy, such as DAO forks, may begin with several arbiters who are not anonymous. In some cases it is possible arbiters are not even randomly chosen, but are respected figures in the field specified during contract creation. In such cases a dispute may be coded to begin when a quorum percentage of members triggers the break.

Appeals are a challenging element of the Distributed Jurisdiction system, since contradictory demands need to be satisfied. Due to the potential anonymity of claimants, the assets of the contract should be bound by the first smart contract until the end of all possible appeals, which puts the goals of careful deliberation and timely resolution at odds. The crowd-sourced efficiency of the open comment system as an experimental proving ground for good practices is again invoked to give solutions for this challenge.

Triage

The details of smart contract creation given above place a significant intellectual burden on the parties—they need to be experts in which type of contract to choose and then which type of dispute resolution protocol is appropriate including weights of expertise tags in various areas of law. It is assumed that the forum will solve many such problems, creating standardized contract templates that are easy to choose for the vast majority of business needs. However, there will always be novel situations, and in order to make the platform more attractive to business use, another layer will be developed which adds a 4th party triage expert who can make such decisions after a dispute starts.

Under this more complicated system, contracting parties can simply add a randomly selected triage expert to their smart contract. Triage expertise will be a separate tree in the forum. A triage expert will have reputation in the expertise of deciding the areas of case law general contracts fall. The smart contract gives this triage expert the ability to transfer part of the adjudication fee and the power of asset disbursement to the appropriate expertise tags to randomly select an appropriate arbiter. Then following the general Distributed Jurisdiction platform function, the triage expert will submit their work for evaluation by other triage experts to the forum.

Attacks

In addition to the general attacks listed in § III.1, this dispute resolution example is susceptible to another type of corruption: arbiters may be bribed. When both arbiters and parties are anonymous and the channels of communication are carefully limited, this is far less likely than in legacy legal systems.

However, when the bench is limited or when anonymity is neglected, the danger may seem more pronounced than it is in the traditional court system. For instance, an anonymous judge has the opportunity to blackmail a known claimant. Or when an arbiter's pseudonymous identity is revealed, a claimant may attempt a bribe. Or when the bench is small, a powerful private user could spend a great deal of money engaging the bench with separate contracts beforehand, as happens today in the U.S. when traditional judges are given regular consulting fees by powerful firms to ensure preferential treatment in the future.

For such situations, the system of checks and balances greatly inhibits the potential for corruption. Arbiters are highly incentivized to maintain probity, since their evidence-of-work post will be policed by the entire bench of arbiters with the threat of loss of availability stake. If that is not enough to dissuade corruption, the potential of diminishing the value of all of their reputation is high if they manage to hurt the reputation of the expertise tag.

Further, smart contracts written as suggested above give insurance an unfair settlement will never occur if 1) anonymous arbiters are randomly chosen according to the weight of their availability stakes, 2) arbiters are required to post evidence-of-work posts for evaluation by the forum, 3) claimants are given automatic space in the post for comments, and 4) a system of appeals is included. In this case, the policing of unfair adjudication is automatic, and the existence of appeals severely weakens the power of bribery.

Freedom of Contract

Distributed Jurisdiction epitomizes the principles associated with the freedom of contract. Smart contracting parties may choose contractual terms to incentivize contract formation or protect themselves from unwanted outcomes, especially in an anonymous contracting environment. Such choices may not always be the most economical but may protect parties to smart contracts. Below we list some forms of contractual terms that parties to smart contracts may consider.

Symmetric Encumbrances

Once a break clause is triggered, the contract in question is suspended in its current state. In the crypto economy, where the anonymity of one or both parties is to be expected, the assets in dispute (money, property, reputation, etc.) need to be bound in the smart contract. In the blockchain environment it is impractical to seek assets from an anonymous party who may have transferred the assets to new anonymous parties during the interim. Further, it would be damaging to the business platform to make the attempt to retrieve assets of a dispute from outside anonymous parties further down the transaction tree.

Therefore, it is incumbent upon the parties not to enter into an asymmetric contract of bound assets, lest one party may unfairly exert power over the other by encumbering assets in a dispute.

For a party to a smart contract that provides services, for instance, symmetric encumbrance may mean that the service provider stakes reputation tokens. Thus, for simple contracts, the Distributed Jurisdiction may be seen as an efficient solution for bringing an escrow service to transactions, small and large.

Plaintiff Stake

To discourage abuse of the remediation process, it is expected (but not necessary) that a plaintiff will add a fee to the contract, called a plaintiff stake, in order to trigger the break clause. In the event of a frivolous dispute, the plaintiff's stake will be disbursed by the arbiter between the defendant and the Distributed Jurisdiction platform. The size of the stake will be specified by the smart contract, determined previously by the parties.

Human Language

In order to use a human arbiter, it is expected (but not necessary) that many contracting parties will attach a human language version of the contract to clarify intent between parties and for the arbiter's use in the case of a dispute, as in a Ricardian contract.

### Example: Company Organization

Any type of collaboration may be organized through the platform in order to vest users with work-verified reputation. As an example consider the following hypothetical development of a company within the platform.

Adam has an idea to create a product, and creates an expertise tag, E1, with an arbitrary amount of currency, say for example, 10 units. Automatically 10 reputation tokens of type XRP-E1 are minted and added to Adam's new expert account. Adam, as founder and sole owner, has complete power as CEO over the evolution of the E1 expertise tag/company, until choosing to relinquish control to trusted experts who have proven their value, or by selling his reputation tokens.

In order to attract outside talent and resources, Adam posts to the E1 tree of the forum his plans for the company's structure and future development and policies for joining. Public users apply for positions within the company/expertise tag by posting to the E1 tree, following Adam's posted protocols, e.g., by staking currency less than 1/10th Adam's original stake, leaving Adam controlling share of the company. Adam evaluates and accepts or rejects each post.

The accepted public applicants are vested with power in the company according to their holdings of reputation tokens granted by Adam. These new experts may now influence the direction of the company/expertise tag by posting evidence of work and evaluating other's work. Adam retains control by using his outsize share to enforce protocols which protect his majority.

Through work verified in the forum by the betting pool, the company eventually increases its value until it can credibly promise a product to the public in the E1 tree of the forum.

E1-approved smart contracts are engaged to deliver the product. These contracts specify product details, fees, and the particular experts which will provide the product. To collect the fees, evidence of delivery is posted to the forum, with comments from the public party, for evaluation by the company experts. This system automatically provides an open record of business that can be evaluated by the public to determine the trustworthiness of the company.

Share sales in the company can be announced and organized in many ways through the forum. One approach is for public investors to post stakes to the forum as empty comments. Those who are accepted (presumably because they didn't try to purchase too many tokens) gain reputation tokens, which vests them with the rights to a (variable) fraction of company decision-making power and all future fees the expertise tag/company collects. The ability of the experts to change the exchange rate between off-platform currency fees and company reputation tokens as explained in § 4F makes stock creation easy.

Creating a company is very efficient on the platform. The open record of its entire history means it is easy to copy the structure and organization of successful companies.

### Example: Proof of Stake

Blockchain theorists are attempting to improve on the proof-of-work protocols initially deployed on the Bitcoin platform, in order to decrease the energy it takes to cryptographically secure transactions. The platform provides one means of safely implementing so-called proof-of-stake protocols.

Instead of solving the complicated proof-of-work hash puzzles, proof-of-stake protocols dictate that a lottery is held amongst users with verified reputation. The lottery determines who gets to add the next block in the blockchain, claiming the fee reward.

Using the platform, experts will stake their reputation to determine their weighted likelihood of being selected in the lottery, an availability stake as detailed in § II. Instead of the lottery winner collecting the fees from the block of transactions, the fees will be paid in reputational salary to all verified experts. Then newly minted tokens of the same quantity as the fees are staked ½ for the lottery winner and ½ against in the betting pool. This gives the rest of the experts the opportunity to evaluate the validity of the lottery winner's block. The lottery winner is rewarded with the majority of the new reputation tokens if the block is valid. The rest of the experts are rewarded with smaller shares of the newly minted reputation for policing the lottery winner.

Blocks will only be accepted by the network if they have proof of success in a betting pool.

There are many choices possible for deciding the process for accepting new experts. However, the least effort option is stable. If the selection process is left open to anyone who wishes to pay any fee, the system is unlikely to be corrupted by the following reasoning. The cost to buy 51% of the reputation tokens was calculated in § III.1.c). In the worst-case scenario, when anyone can add any number of fees and be vested immediately, without review, and no other users are adding any fees beside the malicious users, it will cost much more than twice the total number of reputation tokens, g_0. If the malicious group is merely doubling the rest of the world-wide investment in continuous fee payments, then it will take more than 6 times as much as the global reputation of the system. If the malicious group attempts larger lump payments instead of continuous micro-investments, it will require a far higher outlay.

There are two reasons a malicious group might wish to profit off the system by making a flawed block, either to profit by stealing the fees from the particular block or to destroy trust in the entire blockchain.

Assuming the malicious group does manage to take over the platform, the rest of the world would immediately see the unfair action that couldn't be rectified by the good-faith actors, so the platform would topple. The malicious group would merely gain the (fraction) of the fee from one block. As long as any single fee is smaller than twice the total reputation, there is no incentive to attempt to game the system for fees.

The only other reason to act maliciously is to destroy the platform. But then the >>2g₀ invested becomes worthless. So the cost at any time to topple the system is more than twice the total reputation tokens—assuming you can simply buy reputation without any temporal limit.

Therefore as long as the fees are low compared to the reputation total, or if there is no competitor that is suffering by the platform's existence by more than twice the total number of reputation tokens, there is no incentive to corrupt the system—it is far more valuable to use such power to improve the platform.

As fees are added, reputation is added, so the system becomes more secure as it is used.

Further, if a malicious actor wants to strike, they need to strike immediately. Their corrupt reputation tokens become less valuable if they don't use them, as each new fee they didn't add to the system adds to other peoples' tokens, diminishing the value of older tokens.

Finally, even if there are many different malicious actors in the system, if no single malicious group gains 51% control, they will never be able to corrupt a block.

### Example: Machine Arbiters

Consider the example of a decentralized system which facilitates the cooperation between two machines, Alice and Bob. The goal is to complete a fair exchange between two parties, i.e., a transaction where Alice and Bob transfer files between each other per previous agreement. A classical problem is inventing a protocol which guarantees both parties fulfill their promises by including Ted, a third party (machine) arbiter which gains control of the files if either party signals dissatisfaction.

Under certain restrictive assumptions, it has been proven that no protocol can be created which will guarantee fair exchange with decentralized arbiters. The architecture provides a means for developing a platform which can give users confidence that business can proceed through a system of verified reputation. This gives a calculable probability of confidence, even if no mathematically certain algorithm exists.

By creating a “Fair Exchange Machine Arbitration” expertise tag in the forum, experts can gain reputation by 1) providing effective smart contracts allowing the public to use the expertise tag for arbitration, 2) fairly resolving automated disputes, and 3) posting evidence to advertise the insurance the tag provides. Each time an expert is used, the bench experts benefit, which motivates the healthy development of the expertise tag. Each time an arbiter gives an unfair judgment, appeals have the opportunity to correct the decision, so the offending arbiter would likely be punished with loss of stake and blacklisting.

There is no absolute certainty using the expertise tag will result in a fair resolution. Malicious experts can always choose to use an unfair algorithm to distribute the assets. In that case, however, appeals and blacklisting prevent them from gaining immediate rewards and future power. Thus, a probabilistic confidence in fair resolution will evolve that will increase with the value of the reputation tag.

The number of fair decisions and honest arbiters are statistics available for public analysis through the open record of historical performance. The rate of fees paid to the expertise tag through public use are statistics collectable from the forum, so the value of reputation tokens in the expertise tag is open to public analysis. Therefore, each transaction value has a numerically verifiable confidence level at which the expertise tag can guarantee fair arbitration.

Through increased use, the transaction values the expertise tag can handle will continually increase, along with their confidence level.

### Example: Oracles

An oracle for a blockchain is a system that allows smart contracts to access real-world (i.e., off-chain) data. Since the blockchain is an autonomous system with no centralized authority dictating decisions, there is a need for a trusted 3rd party to state the results of real world events. For instance, when blockchain users wish to exchange a smart contract which mimics a stock option, they need agreement on the value of the stock at the expiration date, which generally requires a trusted 3rd party. For the success of the crypto economy, the 3rd party should remain decentralized and anonymous. The platform gives such 3rd parties an opportunity to establish verified and valuable reputation.

There are many uses for oracles on an autonomous distributed system, and there are many approaches to creating oracles on the platform. One simple approach is to create several oracle expertise tags, consisting of expertises devoted to deciding the outcomes of real world events in various subjects, such as sports, political races, stock prices, weather, etc. The forum hosts the posts of reported outcomes, the veracity of which is decided by the betting pool.

Smart contracts can be written to choose the duration of the betting pool, within some limits decided by the bench experts in the particular expertise tag relevant to the subject matter being decided. For instance, sports bets may have a time scale in days, whereas weather reporting may be automated and occur on the scale of minutes. The betting pool may conclude before the event occurs to enable speculative pools, or after the event occurs to allow bench review of a judgment about the past.

Smart contracts developed in the forum, would call bench experts (as stated before, we encourage random selection weighted by reputation) to write posts in the forum stating the truth of an event, which would then be evaluated for veracity by the rest of the bench through the betting pool as described previously. Specifically, the smart contract gives the chosen bench expert the power to send the fee in the expert's name to the platform, which then mints reputation tokens, stakes half in the chosen experts name for the bet and half in the bench's names against. The betting pool is resolved and the tokens are distributed, then the fees go to salaries for the bench weighted by reputation.

For complicated and messy real world outcomes, human judgment may be necessary. But for many oracle needs, such as reporting stock prices, the entire system could be automated and therefore requires smaller fees to achieve stability.

Attack Resistance

In any open system it is important to identify security weaknesses. A particularly challenging aspect of any reputational system with anonymous accounts is the ability to influence the platform by purchasing reputation tokens for Sybil accounts. The platform's system of checks and balances addresses these problems. In addition to Sybil attacks and tyranny of the majority discussed above in § III.1.a) and § III.1.b), we address further potential points of failure in this section.

Buying Reputation Tokens

Here we discuss 3 ways to corrupt the system by purchasing reputation tokens. The first two approaches corrupt individual established expertise tags. The third approach corrupts the larger platform by creating a new sham expertise tag. Their effects are diminished by the checks and balances of the architecture.

First, anonymous expert accounts can be sold.

Little can be done to combat the first abuse, except to advertise expert accounts which are caught in the attempt. Such accounts would be carefully policed (by the experts within an expertise) and appeals could be used to reverse abuses. Smart contracts can be written to avoid blacklisted accounts.

However, purchasing reputation tokens to unjustly profit when your true expertise does not match your reputation is not a particularly sound investment. The real value of a reputation token is in using its voting power wisely, to gain more reputation tokens, and then collect the salary from fees to the expertise tag. As illustrated in § III.4.b) Reputation calculations, a single token's value is diluted in time as more reputation tokens are added to the platform with each fee collected.

Further, the system polices unproductive work automatically. If the purchased account damages their expertise tag with counterproductive work, it is likely they will quickly lose their reputation tokens. If a purchased account actually improves the platform with verified productive work, then from the point of view of the system, no corruption has occurred.

Second, smart contracts can be created to pump reputation tokens into Sybil accounts.

Since smart contracts can be created in any way desired, this second attack may be instituted by specifying the expert they want to use, no appeals, and give limited information about the case, appealing to privacy. This attack is strengthened if stare decisis is used.

However, this second attack would have limited effect as they would share the reputation equally with the platform if they won the judgment post bet. More importantly, the attack would fail when the system's faithful experts voted against them, as attackers would lose all the staked reputation tokens. This is likely for suspicious posts described in the previous paragraph when attacking a healthy expertise tag with clear protocols for good practices.

Therefore, the system inhibits the corrosive power of purchasing of reputation tokens.

Further, any expertise tag which is corrupted will not be used, and it is easy to create a competing expertise tag to replace it (name it “Version 2”). Thus, there is no incentive to deliberately harm any expertise tag's tree in this way. It takes time, money, and effort to gain power in the expertise tag; you can only harm the system with the power you have; it is easy to police this open system; and harming the platform harms your investment.

Further, as noted above and in § III.4.b), purchasing reputation tokens is not a particularly sound investment, as the true value of a reputation token is in using its voting power wisely, to gain more reputation tokens, and then collect the salary from fees to the expertise tag.

Third, sham expertise tags can be created.

Part of the power and efficiency of the platform includes the ability to easily create expertise tags. The open forum gives a record of work and business for any successful expertise tag, which can easily be copied and reposted under a new tag name for the low cost of the anti-DoS fees. The capital used to mimic fees paid to the sham expertise tag is mostly recovered by the sham owners through the salaries they control.

When the implementation of the platform is open, decentralized, and anonymous, we provide no mechanism to stop the formation of such sham expertise tags.

How, then, is the public able to decide which expertise tag is reputable? In the same way we know clones of websites are untrustworthy, the open record of the history of similar reputation tags gives the public the power it needs to make an informed choice. E.g., precedence and longevity are easily comparable, between reputable and sham expertise tags.

Accumulation of Reputational Power

The inevitable accumulation of reputation tokens by anonymous users is another potential source of corruption. Reputational power can be sold via the sale of anonymous identities. Such corruption is checked by the existence of 51% good-faith users, who will vote fairly in the betting pools. If 51% of users collude to maliciously enrich themselves, nothing can prevent them, except the open system itself, which would quickly detect such an attack. This revelation would gut the value of the system in which the attackers have a majority holding, since public users would no longer send the expertise tag fees, so the strategy is ultimately counter to their interests.

Secondly, as the system reaches maturity, the power of experienced experts will far outstrip that of new experts. Especially in a system which requires staking reputation in order to adjudicate disputes, how are new experts able to earn reputation? New experts may post comments using stakes with currency. If their comments are accepted by the community, they will gain reputation, since more than half their currency stake is returned to them as reputation tokens. But the review system prevents malicious users from simply buying reputation tokens, since comments that are not perceived as improving the platform lose their stake.

The accumulation of power in the platform is naturally mitigated by the constant influx of reputation. As disputes are settled and fees are collected, the fees are continually converted into new reputation tokens. Since the system splits wages equally among users relative to total system reputation, older reputation tokens constantly lose power as time goes by. Therefore, powerful users can only maintain their positions by adding useful work to the platform. See § 8 on reputation calculations.

Finally, any expertise tag which is corrupted will not attract outside fees, and it is easy to create a competing expertise tag to replace it. Thus there is no incentive to deliberately harm any expertise tag in this way, because it takes money and effort to gain power in the expertise tag, you can only harm the system with the power you have, it is easy to police this open system, and harming the platform harms your investment.

DoS Attacks

Spam or DoS attacks are inhibited as usual with nominal fees for new posts as determined by the platform. This would be handled automatically in the case of Ethereum as every transaction requires ether.

Reputation Doesn't Perfectly Reflect Expertise or Effort

Comments which are not controversial are not rewarded. A comment which makes a clear improvement to the platform, assuming it is extremely popular and universally upvoted, will not be directly rewarded since there would be no contrarian reputation staked.

Similarly, successful comments give their posters no greater reward than their fellow upvoters receive. So the same reward is given for crafting a comment as is given for reading and voting, which encourages voting over commenting.

51% Attack

One way to game the system if there are 51% malicious actors is to vote against common sense, thus taking a good percentage of the community's resources. In an open system, however, such an attack would be quickly apparent. This would erode trust in the platform and therefore use and fees, making the 51% holding of reputational salary less valuable. Therefore this tactic merely has the potential to destroy the expertise tag, not enrich the attackers.

It is to be understood that systems and methods according to the present invention may be implemented on one or more processors and one or more memories, as generally known in the computer arts.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for establishing and verifying reputation in a system in which one or more posters provide one or more posts and one or more experts evaluate the posts, said method comprising:
accepting a post at one or more processors in a forum from the one or more posters;
generating via said one or more processors a first set of reputation tokens upon the acceptance of the post;
providing a betting pool administered by said one or more processors;
automatically staking a first half of the first set of reputation tokens via said one or more processors in favor of a first proposition that the post improves expertise within the forum;
automatically staking a second half of the first set of reputation tokens via said one or more processors in favor of a second proposition that the post does not improve expertise within the forum;
submitting via said one or more processors the post to a betting pool process in which one or more experts may bet on whether or not the post improves expertise;
allowing the one or more experts to wager a second set of reputation tokens via said one or more processors depending on whether or not they believe the post improves expertise, the wagered second set of tokens and the first set of tokens comprising wagered tokens;
tallying the wagered tokens via said one or more processors and determining a winning proposition from between the first and second propositions based on which proposition has received more wagered tokens; and
allocating via said one or more processors the first set of wagered tokens and the second set of wagered tokens to the experts who wagered on the winning proposition and, if the first proposition wins, to the poster.

2. The method of claim 1 wherein if the first proposition wins the poster's reputation within the forum is increased.

3. The method of claim 1 wherein if the second proposition wins the poster's reputation within the forum is decreased.

4. The method of claim 1 wherein the one or more experts are anonymous.

5. The method of claim 1 wherein the forum is open and accepts posts from public posters.

6. The method of claim 1 wherein the one or more posts are organized within trees that are constructed within the forum.

7. The method of claim 4 wherein each tree represents an expertise, and the one or more posts are nodes within the trees.

8. The method of claim 1 further comprising, prior to accepting a post, creating the forum by providing a first set of trees corresponding to a first set of expertises.

9. A system for establishing and verifying reputation in a system in which one or more posters provide one or more posts and one or more experts evaluate the posts, said system comprising:
one or more processors; and
one or more memories;
wherein the one or more processors are configured to execute machine readable instructions stored in the one or more memories that cause the one or more processors to:
accept a post in a forum from the one or more posters;
generate a first set of reputation tokens upon the acceptance of the post;
provide a betting pool;
automatically stake a first half of the first set of reputation tokens in favor of a first proposition that the post improves expertise within the forum;
automatically stake a second half of the first set of reputation tokens in favor of a second proposition that the post does not improve expertise within the forum;
submit the post to a betting pool process in which one or more experts may bet on whether or not the post improves expertise;
allow the one or more experts to wager a second set of reputation tokens depending on whether or not they believe the post improves expertise, the wagered second set of tokens and the first set of tokens comprising wagered tokens;
tally the wagered tokens and determine a winning proposition from between the first and second propositions based on which proposition has received more wagered tokens; and
allocate the first set of wagered tokens and the second set of wagered tokens to the experts who wagered on the winning proposition and, if the first proposition wins, to the poster.

10. The system of claim 9 wherein the one or more experts are anonymous.

11. The system of claim 9 wherein the forum is open and accepts posts from public posters.

12. The system of claim 9 wherein the one or more posts are organized within trees that are constructed within the forum.

13. The system of claim 12 wherein each tree represents an expertise, and the one or more posts are nodes within the trees.

14. The system of claim 9 wherein the one or more processors are further configured to execute machine readable instructions stored in the one or more memories that cause the one or more processors to:
create the forum, prior to accepting a post, by providing a first set of trees corresponding to a first set of expertises.

15. A method for establishing and verifying reputation in a system in which one or more posters provide one or more posts and one or more experts evaluate the posts, said method comprising:
accepting a post at one or more processors in a forum from the one or more posters;
generating via said one or more processors a set of tokens upon the acceptance of the post;
providing a betting pool administered by said one or more processors;
automatically staking a first half of the tokens via said one or more processors in favor of a first proposition that the post improves information within the forum;
automatically staking a second half of the tokens via said one or more processors in favor of a second proposition that the post does not improve information within the forum; and
submitting via said one or more processors the post to a betting pool process in which one or more experts may bet on whether or not the post improves information in the forum.

16. The method of claim 15 wherein the one or more experts are anonymous.

17. The method of claim 15 wherein the forum is open and accepts posts from public posters.

18. The method of claim 15 wherein the one or more posts are organized within trees that are constructed within the forum.

19. The method of claim 18 wherein each tree represents an expertise, and the one or more posts are nodes within the trees.

20. The method of claim 15 further comprising, prior to accepting a post, creating the forum by providing a first set of trees corresponding to a first set of expertises.
